(19) United States
(12) Patent Application Publication
(10) Pub. No.: US 2025/0128911 A1
(43) Pub. Date: Apr. 24, 2025

(54) A SYSTEM AND A METHOD FOR DETECTING POSITION AND CONTROLLING SPEED OF AN ELEVATOR CABIN

(71) Applicant: RUPHAVATHY VISHAL, CHENNAI (IN)

(72) Inventor: RUPHAVATHY VISHAL, CHENNAI (IN)

(21) Appl. No.: 18/292,020

(22) PCT Filed: Nov. 22, 2023
(86) PCT No.: PCT/IB2023/061772

§ 371 Date: Jan. 25, 2024

(30) Foreign Application Priority Data
Dec. 30, 2022 (IN) 202241077162

(51) Int. Cl. B66B 1/28; B66B 1/34; B66B 5/06; B66B 9/04; B66B 11/00; G01S 17/58

(52) U.S. Cl. CPC B66B 1/28; B66B 1/3492; B66B 5/06; B66B 9/04; B66B 11/0025; G01S 17/58

(57) ABSTRACT

A system (100) for detecting a position and controlling a speed of an elevator cabin (102) is disclosed. The system includes a plurality of light detection and ranging sensors (LiDAR) (104) and a shaft controller (110). The plurality of LiDAR is positioned at a ceiling (106) and at a floor (108) of the elevator (300), facing towards the elevating cabin. The plurality of LiDAR is configured to read and transmit, the distance of the elevator cabin from at least one of ground and a topmost position of the elevator and the speed of the elevator cabin by reading the distance travelled per unit of time. The shaft controller detects the position of the elevator cabin by receiving the distance from the plurality of LiDAR. The shaft controller also detects an overspeed condition when the speed of the elevator cabin received from the plurality of LiDAR is above safe threshold speed.

### CROSS-REFERENCE TO RELATED APPLICATION

This application claims priority from a Complete Patent application filed in India having patent application No. 202241077162, filed on Dec. 30, 2022, and titled “A SYSTEM AND A METHOD FOR DETECTING POSITION AND CONTROLLING SPEED OF AN ELEVATOR CABIN” and a PCT Application No. PCT/IB2023/061772 filed on Nov. 22, 2023, and titled “A SYSTEM AND A METHOD FOR DETECTING POSITION AND CONTROLLING SPEED OF AN ELEVATOR CABIN.”

### FIELD OF INVENTION

Embodiments of the present disclosure relate to elevators and more particularly to a system and a method for detecting a position and controlling a speed of an elevator cabin.

### BACKGROUND

The development of elevators was led by the need for the movement of heavy materials and lifting goods. The elevators provide easy transportation and are time-saving technology. Also, the elevators have space-saving designs, enhanced security, are useful in emergency situations, and the like. Several types of elevators are available such as pneumatic elevator systems, vacuum elevator systems, and the like.

Although there are many advantages and disadvantages of elevators. The disadvantages include bearing malfunction, technical issues such as over speeding, rough landing, and the like. The existing elevator system faces unnecessary stop situations in case of over speeding conditions. In addition, the unnecessary braking of the elevator and speed-raising also increase the extra mechanical wear of the elevator, thereby have reduced the service life of the elevator.

The current systems addressing these issues require a complicated circuit, integrated with a lot of sensors and thus making the elevator difficult to assemble and deploy. Also, with advancements in technology, the elevators utilize a series of sensors, controllers, sequences of operation, real-time calculations, or algorithms. The elevator sensors provide data on cabin positions, cabin moving direction, loads, door status, cabin calls, number of runs per cabin, alarms, and the like. In the exiting vacuum elevator systems, the speed and direction control are based on position sensors which require the elevator to go slightly beyond the actual stopping point and return to the stopping location taking a few additional seconds. Conventional automatic elevators utilize relay logic controllers to control the speed, position, and door operation of the elevator. The currently existing complicated circuit-based elevators have limitations in relation to processing capability and speed. In any control system for an elevator, it is undesirable to have delays in processing and transmitting critical information, such as safety information.

Hence, there is a need for a system and a method for detecting a position and controlling a speed of an elevator cabin to address the aforementioned issue(s).

### BRIEF DESCRIPTION

In accordance with an embodiment of the present disclosure, a system for detecting a position and controlling a speed of an elevator cabin is provided. The system includes a plurality of light detection and ranging sensors and a shaft controller. The plurality of light detection and ranging sensors are positioned at a ceiling and at a floor of the elevator, facing towards an elevating cabin. The plurality of light detection and ranging sensors is configured to read and transmit the distance of the elevator cabin from at least one of a ground and a topmost position of the elevator. The plurality of light detection and ranging sensors is also configured to read and transmit the speed of the elevator cabin by reading the distance travelled per unit of time. The shaft controller is operatively coupled with the plurality of light detection and ranging sensors. The shaft controller is configured to detect a position of the elevator cabin by receiving the distance of the elevator cabin read by the plurality of light detection and ranging sensors. The position is detected by measuring the distance from the ground to the floor of the elevator cabin and from the topmost position of the elevator to a ceiling of the elevator cabin. The shaft controller is configured to detect an overspeed condition when the speed of the elevator cabin received from the plurality of light detection and ranging sensors is above a safe threshold speed.

In accordance with another embodiment of the present disclosure, a method for the operation of a system for detecting the position and controlling the speed of an elevator cabin is provided. The method includes reading and transmitting, by a plurality of light detection and ranging sensors, distance of the elevator cabin from at least one of a ground and a topmost position of the elevator. The method also includes reading and transmitting, by a plurality of light detection and ranging sensors, the speed of the elevator cabin by reading the distance travelled per unit of time. Further, the method includes detecting, by a shaft controller, a position of the elevator cabin by receiving the distance of the elevator cabin read by the plurality of light detection and ranging sensors by measuring the distance from the ground to floor of the elevator cabin and from the topmost position of the elevator to a ceiling of the elevator cabin. Furthermore, the method includes detecting, by the shaft controller, an over speeding condition when the speed of the elevator cabin received from the plurality of light detection and ranging sensors is above a safe threshold speed. Furthermore, the method includes controlling, by the shaft controller, the speed of the elevator cabin by activating and deactivating a speed control unit upon detection of the over-speed condition.

In accordance with yet another embodiment of the present disclosure, a pneumatic vacuum is provided. The elevator includes an external cylinder assembly includes an elevator cabin inserted therein. The external cylinder assembly includes a plurality of cylinders coupled using a base ring assembly and a band ring assembly. The external cylinder assembly includes a guide rail pillar mechanically coupled to the elevator cabin. The guide rail pillar is disposed at the external cylinder assembly. The guide rail pillar is configured to guide an actuation of the elevator cabin. The elevator also includes a polycarbonate sheet is configured to cover the external cylinder assembly. The polycarbonate sheet and the external cylinder assembly is coupled using a first locking device and a second locking device. The first locking device is configured to lock an air gap between the polycarbonate sheet, the base ring assembly, and the external cylinder assembly, and the second locking device is configured to lock the air gap between the polycarbonate sheet and the guide rail pillar. The elevator also includes a seal assembly adapted to fit over a top portion of the elevator cabin. The seal assembly is configured to seal the elevator cabin to reduce vibrations during the upward and downward movement of the elevator cabin. The seal assembly includes a depressurizing system configured to prevent the elevator cabin from coming into force contact with the external cylinder assembly during upward movement and contribute to safety of an elevator operation. Further, the elevator also includes a plurality of light detection and ranging sensors positioned at a ceiling and at a floor of the elevator, facing towards an elevator cabin. The plurality of light detection and ranging sensors are positioned at a ceiling and at a floor of the elevator, facing towards an elevating cabin. The plurality of light detection and ranging sensors is configured to read and transmit the distance of the elevator cabin from at least one of a ground and a topmost position of the elevator. The plurality of light detection and ranging sensors is also configured to read and transmit the speed of the elevator cabin by reading the distance travelled per unit of time. The shaft controller is operatively coupled with the plurality of light detection and ranging sensors. The shaft controller is configured to detect a position of the elevator cabin by receiving the distance of the elevator cabin read by the plurality of light detection and ranging sensors. The position is detected by measuring the distance from the ground to the floor of the elevator cabin and from the topmost position of the elevator to a ceiling of the elevator cabin. The shaft controller is configured to detect an overspeed condition when the speed of the elevator cabin received from the plurality of light detection and ranging sensors is above a safe threshold speed.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for detecting a position and controlling a speed of an elevator cabin in accordance with an embodiment of the present disclosure;

FIG. 2 is a block diagram an exemplary embodiment of a speed control unit with a plurality of light detector and ranging sensors of FIG. 1, in accordance with an embodiment of the present disclosure;

FIG. 3 is a schematic representation of system for detecting a position and controlling a speed of an elevator cabin of FIG. 1 in accordance with an embodiment of the present disclosure;

FIG. 4 is a schematic representation of a pneumatic vacuum elevator in accordance with an embodiment of the present disclosure; and

FIG. 5 is a flow chart representing the steps involved in a method for detecting a position and controlling a speed of an elevator cabin in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for detecting a position and controlling a speed of an elevator cabin. The system includes a plurality of light detection and ranging sensors and a shaft controller. The plurality of light detection and ranging sensors are positioned at a ceiling and at a floor of the elevator, facing towards an elevating cabin. The plurality of light detection and ranging sensors is configured to read and transmit the distance of the elevator cabin from at least one of a ground and a topmost position of the elevator. The plurality of light detection and ranging sensors is also configured to read and transmit the speed of the elevator cabin by reading the distance travelled per unit of time. The shaft controller is operatively coupled with the plurality of light detection and ranging sensors. The shaft controller is configured to detect a position of the elevator cabin by receiving the distance of the elevator cabin read by the plurality of light detection and ranging sensors. The position is detected by measuring the distance from the ground to the floor of the elevator cabin and from the topmost position of the elevator to a ceiling of the elevator cabin. The shaft controller is configured to detect an overspeed condition when the speed of the elevator cabin received from the plurality of light detection and ranging sensors is above a safe threshold speed.

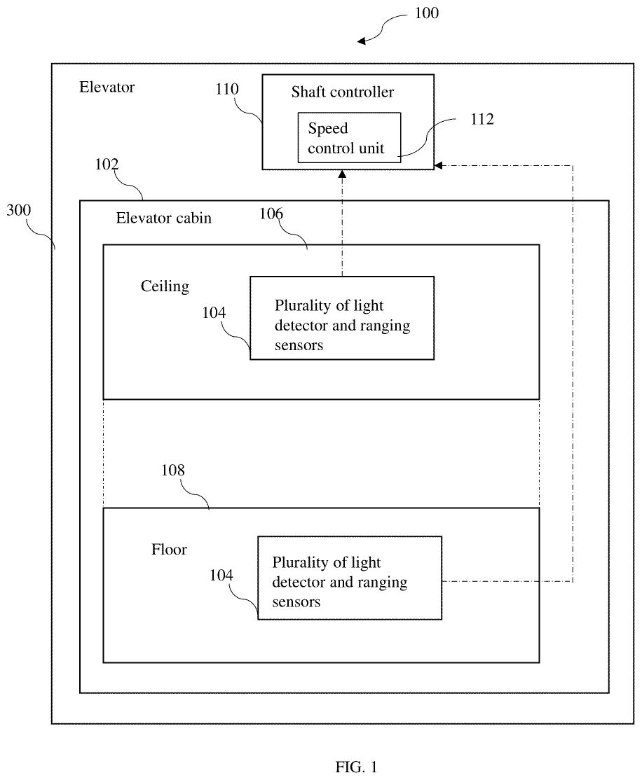

FIG. 1 is a block diagram representation of a system 100 for detecting a position and controlling a speed of an elevator cabin 102. The system 100 includes a plurality of light detection and ranging sensors 104 and a shaft controller 110.

The plurality of light detection and ranging sensors 104 are positioned at a ceiling 106 and at a floor 108 of the elevator 300, facing towards an elevator cabin 102. The plurality of light detection and ranging sensors 104 is configured to read and transmit the distance of the elevator cabin 102 from at least one of a ground and a topmost position of the elevator 300. The plurality of light detection and ranging sensors 104 is configured to read and transmit the speed of the elevator cabin 102 by reading the distance traveled per unit of time. In one embodiment, the light detector and ranging sensor (Lidar) 104 is used to make high-resolution maps and also used in control and navigation for some autonomous equipment. Lidar uses ultraviolet, visible, or near-infrared light to image objects. The LiDAR sensors 104 reads the distance of an object or a surface by the speed of light, and the time spent for the laser light to travel to the object or surface being detected, then travel back to the detector. The LiDAR sensor 104 is connected to the shaft controller 110 thus the distance read by the Lidar sensor 104 is transmitted to the shaft controller 110.

The shaft controller 110 operatively coupled with the plurality of light detection and ranging sensors 104. The shaft controller 110 is configured to detect a position of the elevator cabin 102 by receiving the distance of the elevator cabin 102 read by the plurality of light detection and ranging sensors 104. The position is detected by measuring the distance from the ground to a floor 108 of the elevator cabin 102 and from the topmost position of the elevator 300 to a ceiling 106 of the elevator cabin 102. Also, the shaft controller 110 is configured to detect an overspeed condition when the speed of the elevator cabin 102 received from the plurality of light detection and ranging sensors 104 is above a safe threshold speed. Further, the shaft controller 110 is configured to control the speed of the elevator cabin 102 by activating and deactivating a speed control unit 112 upon detection of the overspeed condition.

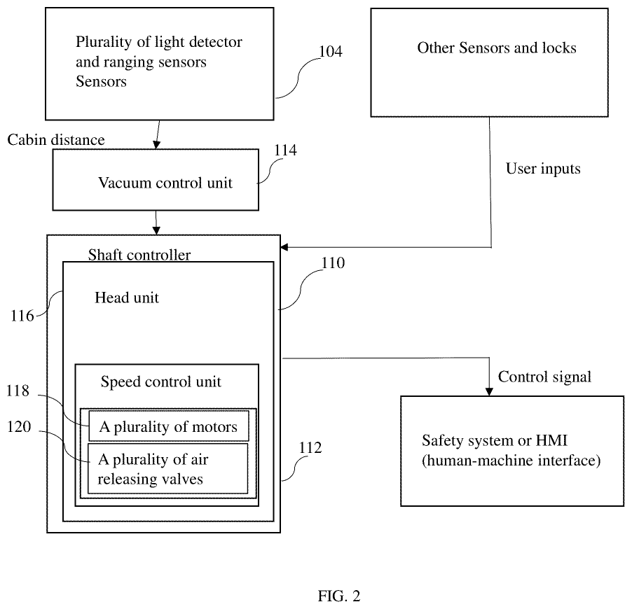

FIG. 2 is a block diagram an exemplary embodiment of a speed control unit 112 with a plurality of light detector and ranging sensors 104 of FIG. 1, in accordance with an embodiment of the present disclosure. The plurality of light detector and ranging sensors 104 is configured to read the distance either from ceiling 106 or from ground continuously during the motion of the elevator cabin 102. In one embodiment, the shaft controller 112 detects calculates the speed at which the elevator cabin 102 travels by using the distance and corresponding time reading. The speed is calculated by reading the distance travelled for every 100 milli second. The speed may be continuously calculated by the shaft controller 112 for further actions. In one embodiment, the speed formula used is as follows:

Speed of cabin (at every 100 ms)=Distance travelled (in 100 ms)/time (100 ms)

The speed of the elevator cabin 102 may be read and monitored continuously during the operation by the plurality of light detector and ranging sensors 104. The live data of the calculated speed is provided to the shaft controller 112. The system arrangement is represented as a block diagram in FIG. 2. The system monitors the speed of the elevator cabin 102 at each control level, as the speed may vary based on the load. The shaft controller 112 calculates and monitors the speed and performs immediate corrective action by activating or deactivating the required number of motors or air-releasing valves or a combination of the different numbers of motors and air-release valves.

Considering a case of over speed during descending, the system 100 may immediately activate the required number of motors 118 and reduce the speed to the safe threshold descending speed. In case of over speed during ascending, the system 100 may immediately deactivate the required number of motors and reduce the speed to the safe threshold ascending speed.

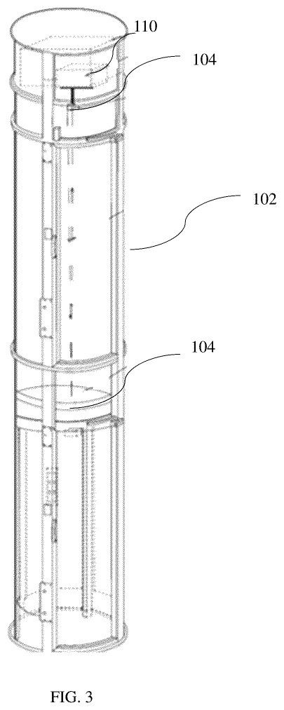

FIG. 3 is a schematic representation of a system 100 for detecting a position and controlling a speed of an elevator cabin 102 of FIG. 1 in accordance with an embodiment of the present disclosure. The plurality of light detector and ranging sensor 104 is positioned at a ceiling 106 and at a floor 108 of the elevator 300, facing towards an elevator cabin 102. In one embodiment, the plurality of light detection and ranging sensors 104 is configured to act as a backup in case of another light detection and ranging sensor from the plurality of light detection and ranging sensors 104 fails. In another embodiment, the light detection and ranging sensor 104 is configured to continuously monitor the distance of the elevator cabin 102 from the ground and the topmost portion of the elevator 300 with the accuracy of 1 cm.

In one embodiment, upon activation or deactivation, the speed control unit 112 of the shaft controller 110, controls the speed of the elevator cabin 102 after detecting of the overspeed condition. In another embodiment, the speed control unit 112 is positioned in a head unit 116, wherein the head unit 116 is positioned at a top portion of the elevator cabin 102. In such an embodiment, the speed control unit 112 includes at least one of a plurality of motors 118 and a plurality of air release valves 120. The plurality of motors 118 upon activation, controls the motion of the elevator cabin 102 in the direction requested by the user. The plurality of air release valves 120 releases the vacuum pressure from the inside of the speed control unit 112 and allows the elevator cabin 102 to elevate in the direction requested by the user. Further, in one embodiment, the speed control unit 112 is configured to be activated for reducing the speed of the elevator cabin 102 to a safe threshold speed, upon detection of the overspeed condition of the elevator cabin 102 during descending motion of the elevator cabin 102. Furthermore, in one embodiment, the speed control unit 112 is configured to be de-activated for reducing the speed of the elevator cabin 102 to the safe threshold speed, upon detection of the over-speed condition of the elevator cabin 102 during ascending motion of the elevator cabin 102.

In one embodiment, the elevator 300 may be a pneumatic elevator. The speed control unit 112 is configured to provide a variation in the shaft pressure above the elevator cabin 102 for facilitating the operation of the elevator 300. The pressure variation is achieved by the number of motors activated during the operation of the elevator cabin 102. The number of motors selected is based on required motion types such as ascending, descending, landing, take off, and the like. Based on the vacuum level the elevator cabin 102 may either ascend or descend.

In one embodiment, the system 100 includes a vacuum control unit 114 positioned at an upper side of the shaft controller 110 for controlling the speed, state, and direction of the elevator cabin 102 by controlling vacuum pressure. In one embodiment, the vacuum pressure is controlled by the vacuum control unit 114 located at the upper side of the shaft, which controls the speed, state, and direction of the elevator cabin 102 as per the requirement of a user. In another embodiment, the elevator cabin 102 motion control method may reduce the need for multiple position sensors and avoid the existing way of stopping at floors to give better user experience.

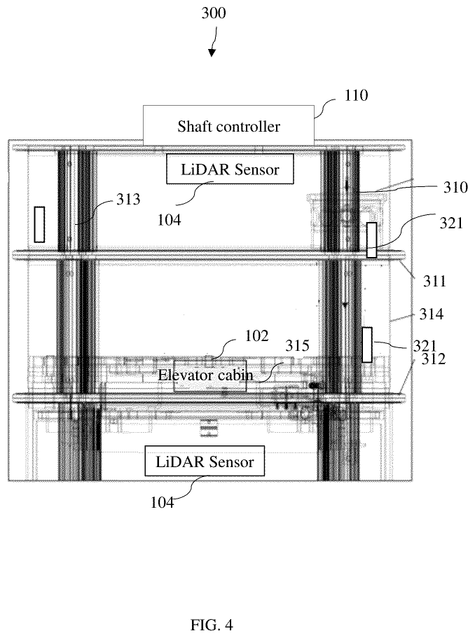

FIG. 4 is a schematic representation of a pneumatic vacuum elevator 300 in accordance with an embodiment of the present disclosure. The pneumatic vacuum elevator 300 includes an external cylinder assembly 310 including an elevator cabin 102 inserted therein. The external cylinder assembly 310 includes a plurality of cylinders coupled using a base ring assembly 311 and a band ring assembly 312.

The pneumatic vacuum elevator 300 also includes a guide rail pillar 313 and a polycarbonate sheet 314. The guide rail pillar 313 is mechanically coupled to the elevator cabin 102. The guide rail pillar 313 is disposed at the external cylinder assembly 310, wherein the guide rail pillar 313 is configured to guide an actuation of the elevator cabin 102. The polycarbonate sheet 314 is configured to cover the external cylinder assembly 310, wherein the polycarbonate sheet 314 and the external cylinder assembly 310 is coupled using a first locking device and a second locking device. The first locking device is configured to lock an air gap between the polycarbonate sheet 314, the base ring assembly 311 and the external cylinder assembly 310 and the second locking device is configured to lock air gap between the polycarbonate sheet 314 and the guide rail pillar 313.

Further, the pneumatic vacuum elevator 300 includes a seal assembly 315 adapted to fit over a top portion of the elevator cabin 102. The seal assembly 315 is configured to seal the elevator cabin 102 to reduce vibrations during upward and downward movement of the elevator cabin 102. The seal assembly 315 includes a depressurizing system configured to prevent the elevator cabin 102 from coming into force contact with the external cylinder assembly during upward movement and contribute to safety of an elevator 300 operation.

Furthermore, the pneumatic vacuum elevator 300 includes a plurality of light detection and ranging sensors 104 positioned at a ceiling 106 and at a floor 108 of the elevator 300, facing towards an elevator cabin 102. The plurality of light detection and ranging sensors 104 is configured to read and transmit distance of the elevator cabin 102 from at least one of a ground and a topmost position of the elevator 300. Also, the plurality of light detection and ranging sensors 104 is configured to read and transmit the speed of the elevator cabin 102 by reading the distance travelled per unit of time.

Furthermore, the pneumatic vacuum elevator 300 includes a shaft controller 110 operatively coupled with the plurality of light detection and ranging sensors 104. The shaft controller 110 is configured to detect a position of the elevator cabin 102 by receiving the distance of the elevator cabin 102 read by the plurality of light detection and ranging sensors 104. The position is detected by measuring the distance from the ground to floor 108 of the elevator cabin 102 and from the topmost position of the elevator to a ceiling 106 of the elevator cabin 102. Also, the shaft controller 110 is configured to detect an overspeed condition when the speed of the elevator cabin 102 received from the plurality of light detection and ranging sensors 104 is above a safe threshold speed. Further, the shaft controller 110 is configured to control the speed of the elevator cabin 102 by activating and deactivating a speed control unit 112 upon detection of the overspeed condition.

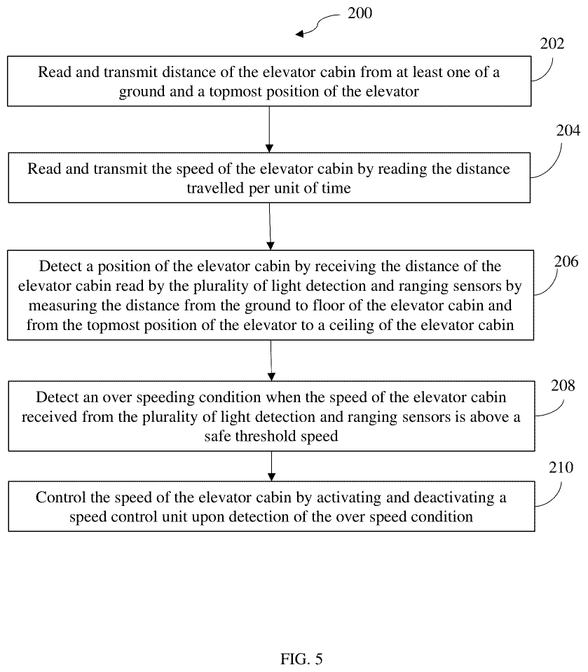

FIG. 5 is a flow chart representing the steps involved in a method 200 for detecting the position and controlling the speed of the elevator cabin in accordance with an embodiment of the present disclosure. The method 200 includes reading and transmitting, by a plurality of light detection and ranging sensors, a distance of the elevator cabin from at least one of a ground and a topmost position of the elevator in step 202. The method also includes the plurality of light detection and ranging sensors is configured to act as a backup in case of another light detection and ranging sensor from the plurality of light detection and ranging sensors fails. The method also includes monitoring, the distance of the elevator cabin from the ground and ceiling (106) with the accuracy of 1 cm.

The method also includes reading, the direction of motion of the elevator cabin based on the destination requested by a user. In one embodiment, the direction towards the requested destination may be an ascending direction of the elevator cabin or a descending direction of the elevator cabin.

The method also includes reading and transmitting, by a plurality of light detection and ranging sensors, the speed of the elevator cabin by reading the distance travelled per unit of time in step 204. The method also includes positioning, the speed control unit in a head unit and the head unit at a top portion of the elevator cabin. The method also includes at least one of a plurality of motors and a plurality of air release valves. The method also includes activating, the plurality of motors and controlling the motion of the elevator cabin in the direction requested by the user. The method also includes releasing, by plurality of air release valves, the vacuum pressure from the inside of the speed control unit and allowing the elevator cabin to elevate in the direction requested by the user.

Further, the method includes activating, the speed control unit during descending motion, for reducing the speed of the elevator cabin to a safe threshold speed, upon detection of the overspeed condition of the elevator cabin. The method also includes de-activating, the speed control unit during ascending motion of the elevator cabin, for reducing the speed of the elevator cabin to the safe threshold speed, upon detection of the over-speed condition of the elevator cabin.

Further, the method includes detecting, by a shaft controller, a position of the elevator cabin by receiving the distance of the elevator cabin read by the plurality of light detection and ranging sensors by measuring the distance from the ground to floor of the elevator cabin and from the topmost position of the elevator to a ceiling of the elevator cabin in step 206.

Furthermore, the method includes detecting, by the shaft controller, an over speeding condition when the speed of the elevator cabin received from the plurality of light detection and ranging sensors is above a safe threshold speed in step (208). The method also includes activating, the speed control unit during descending motion, for reducing the speed of the elevator cabin to a safe threshold speed, upon detection of the overspeed condition of the elevator cabin.

Furthermore, the method includes controlling, by the shaft controller, the speed of the elevator cabin by activating and deactivating a speed control unit upon detection of the over speed condition in step 210. The method also includes de-activating, the speed control unit during ascending motion of the elevator cabin, for reducing the speed of the elevator cabin to the safe threshold speed, upon detection of the over-speed condition of the elevator cabin.

Furthermore, the method 200 includes providing by the speed control unit, a variation in the shaft pressure above the elevator cabin for facilitating the operation of the elevator. The method also includes achieving, the pressure variation by the number of motors activated during the operation of the elevator. The method also includes selecting, the number of motors based on required motion types such as ascending, descending, landing, take off, and the like. The method also includes ascending and descending, the motion of the elevator cabin based on the vacuum level.

Furthermore, the method also includes controlling, by a vacuum control unit, the speed, state, and direction of the elevator cabin by controlling vacuum pressure. The method also includes controlling, the vacuum pressure by the vacuum control unit, and the speed, state, and direction of the elevator cabin as per the requirement of the user. In one embodiment, the elevator cabin motion control method may reduce the need for multiple position sensors and avoid the existing way of stopping at floors to give a better user experience.

Various embodiments of the present disclosure provide a system and a method for detecting the position and controlling the speed of the elevator cabin. The system described in the present disclosure is easy to assemble and deploy. The system provides accuracy in detecting position vacuum elevator systems. The system in the present disclosure enables the elevator cabin to stop at an exact stop location. The system eliminates the existing complicated circuit-based elevators and provides desirable speed control in case of over speeding of the elevator cabin.

The system disclosed in the present disclosure provides energy-saving advantages which result in significant economic benefit and social benefits. The system disclosed in the present disclosure is easy to use and provides safe transportation.

Furthermore, there is no intention to be bound by any expressed or implied theory presented in the preceding technical field, background, brief summary or the detailed description. It is also to be understood that the specific devices and processes illustrated in the attached drawings, and described in the specification, are simply exemplary embodiments of the inventive concepts defined in the appended claims. Hence, specific dimensions and other physical characteristics relating to the embodiments disclosed herein are not to be considered as limiting, unless the claims expressly state otherwise.

While specific language has been used to describe the disclosure, any limitations arising on account of the same are not intended. As would be apparent to a person skilled in the art, various working modifications may be made to the method (250) in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A system 100 for detecting a position and controlling a speed of an elevator cabin 102, wherein the system 100 comprises:
a plurality of light detection and ranging sensors 104 positioned at a ceiling 106 and at a floor 108 of an elevator 300, facing towards an elevator cabin 102, wherein the plurality of light detection and ranging sensors 104 is configured to:
read and transmit distance of the elevator cabin 102 from at least one of a ground and a topmost position of the elevator; and
read and transmit the speed of the elevator cabin 102 by reading the distance travelled per unit of time; and
a shaft controller 110 operatively coupled with the plurality of light detection and ranging sensors 104, wherein the shaft controller 110 is configured to:
detect a position of the elevator cabin 102 by receiving the distance of the elevator cabin 102 read by the plurality of light detection and ranging sensors 104, wherein the position is detected by measuring the distance from the ground to floor 108 of the elevator cabin 102 and from the topmost position of the elevator to a ceiling 106 of the elevator cabin 102;
detect an overspeed condition when the speed of the elevator cabin 102 received from the plurality of light detection and ranging sensors 104 is above a safe threshold speed; and
controls the speed of the elevator cabin 102 by activating and deactivating a speed control unit 112 upon detection of the overspeed condition.

2. The system 100 as claimed in claim 1, wherein one of the plurality of light detection and ranging sensors 104 is configured to act as a backup in case of another light detection and ranging sensor from the plurality of light detection and ranging sensors 104 fails.

3. The system 100 as claimed in claim 1, wherein the light detection and ranging sensor 104 is configured to continuously monitor the distance of the elevator cabin 102 from ground and ceiling 106 with the accuracy of 1 cm.

4. The system 100 as claimed in claim 1, comprises a vacuum control unit 114 positioned at an upper side of the shaft controller 110 for controlling the speed, state, and direction of the elevator cabin 102 by controlling vacuum pressure.

5. The system 100 as claimed in claim 1, wherein the speed control unit 112 is positioned in a head unit 116, wherein the head unit 116 is positioned at a top portion of the elevator cabin 102.

6. The system 100 as claimed in claim 1, wherein the speed control unit 112 comprises at least one of a plurality of motors 118 and a plurality of air release valves 120, wherein:
the plurality of motors 118 upon activation, controls the motion of the elevator cabin 102 in the direction requested by a user; and
the plurality of air release valves 120 releases the vacuum pressure from the inside of the speed control unit 112 and allows the elevator cabin 102 to elevate in the direction requested by the user.

7. The system 100 as claimed in claim 1, wherein the speed control unit 112 is configured to be activated for reducing the speed of the elevator cabin 102 to a safe threshold speed, upon detection of the overspeed condition of the elevator cabin 102 during descending motion of the elevator cabin 102.

8. The system 100 as claimed in claim 1, wherein the speed control unit 112 is configured to be de-activated for reducing the speed of the elevator cabin 102 to the safe threshold speed, upon detection of the over-speed condition of the elevator cabin 102 during ascending motion of the elevator cabin 102.

9. The system 100 as claimed in claim 1, wherein the speed control unit 112 is configured to provide a variation in the shaft pressure above the elevator cabin 102 for facilitating the operation of the elevator.

10. A method 200 for the operation of a system for detecting the position and controlling the speed of an elevator cabin, wherein the method 200 comprises:
reading and transmitting, by a plurality of light detection and ranging sensors, distance of the elevator cabin from at least one of a ground and a topmost position of the elevator; 202
reading and transmitting, by a plurality of light detection and ranging sensors, the speed of the elevator cabin by reading the distance travelled per unit of time; 204
detecting, by a shaft controller, a position of the elevator cabin by receiving the distance of the elevator cabin read by the plurality of light detection and ranging sensors by measuring the distance from the ground to floor of the elevator cabin and from the topmost position of the elevator to a ceiling of the elevator cabin; 206
detecting, by the shaft controller, an over speeding condition when the speed of the elevator cabin received from the plurality of light detection and ranging sensors is above a safe threshold speed; 208 and
controlling, by the shaft controller, the speed of the elevator cabin by activating and deactivating a speed control unit upon detection of the over speed condition. 210

11. A pneumatic vacuum elevator 300 comprising:
an external cylinder assembly 310 comprising an elevator cabin 102 inserted therein, wherein the external cylinder assembly 310 comprises a plurality of cylinders coupled using a base ring assembly 311 and a band ring assembly 312;
a guide rail pillar 313 mechanically coupled to the elevator cabin 102, wherein the guide rail pillar 313 is disposed at the external cylinder assembly 310, wherein the guide rail pillar 313 is configured to guide an actuation of the elevator cabin 102;
a polycarbonate sheet 314 configured to cover the external cylinder assembly 310, wherein the polycarbonate sheet 314 and the external cylinder assembly 310 is coupled using a first locking device and a second locking device, wherein the first locking device is configured to lock an air gap between the polycarbonate sheet 314, the base ring assembly 311 and the external cylinder assembly 310 and the second locking device is configured to lock air gap between the polycarbonate sheet 314 and the guide rail pillar 313;
a seal assembly 315 adapted to fit over a top portion of the elevator cabin 102, wherein the seal assembly 315 is configured to seal the elevator cabin 102 to reduce vibrations during upward and downward movement of the elevator cabin 102,
wherein the seal assembly 315 comprises a depressurizing system configured to prevent the elevator cabin 102 from coming into force contact with the external cylinder assembly during upward movement and contribute to safety of an elevator operation; and
a plurality of light detection and ranging sensors 104 positioned at a ceiling 106 and at a floor 108 of the elevator, facing towards an elevator cabin 102, wherein the plurality of light detection and ranging sensors 104 is configured to:
read and transmit distance of the elevator cabin 102 from at least one of a ground and a topmost position of the elevator; and
read and transmit the speed of the elevator cabin 102 by reading the distance travelled per unit of time; and
a shaft controller 110 operatively coupled with the plurality of light detection and ranging sensors 104, wherein the shaft controller 110 is configured to:
detect a position of the elevator cabin 102 by receiving the distance of the elevator cabin 102 read by the plurality of light detection and ranging sensors 104, wherein the position is detected by measuring the distance from the ground to floor 108 of the elevator cabin 102 and from the topmost position of the elevator to a ceiling 106 of the elevator cabin 102;
detect an overspeed condition when the speed of the elevator cabin 102 received from the plurality of light detection and ranging sensors 104 is above a safe threshold speed; and
controls the speed of the elevator cabin 102 by activating and deactivating a speed control unit 112 upon detection of the overspeed condition.
